(19) United States
(12) Patent Application Publication
(10) Pub. No.: US 2026/0167114 A1
(43) Pub. Date: Jun. 18, 2026

(54) VEHICLES AND SEAT ASSEMBLIES WITH MULTI-ACCESS STORAGE COMPARTMENTS

(71) Applicant: NISSAN NORTH AMERICA, INC., Franklin, TN (US)

(72) Inventors: Andre OLIVEIRA FERNANDES, Walled Lake, MI (US); Tracy SPAGNUOLO, Brighton, MI (US); Mitsuyasu HIKOSAKA, Novi, MI (US); Devon Michael VOGT, Brighton, MI (US)

(21) Appl. No.: 18/986,549

(22) Filed: Dec. 18, 2024

(51) Int. Cl. B60R 7/04

(52) U.S. Cl. CPC B60R 7/043

(57) ABSTRACT

Vehicles and seat assemblies with multi-access storage compartments are disclosed herein. In an embodiment, the vehicle has a passenger cabin, a vehicle seat and a storage compartment. The passenger cabin has a driver side door that opens and closes a driver side door opening and a passenger side door that opens and closes a passenger side door opening. The vehicle seat is located inside the passenger cabin between the driver side door opening and the passenger side door opening. The vehicle seat includes a seat bottom and a seat backrest. The storage compartment is located below the seat bottom. The storage compartment translates between (i) a stowed position enclosed underneath the seat bottom, (ii) a first in-use position in which extending into the driver side door opening, and (iii) a second in-use position extending into the passenger side door opening.

### BACKGROUND

### Field of the Disclosure

The present disclosure generally relates to vehicles and vehicle seat assemblies with easily accessible and/or adjustable storage compartments.

### Background Information

Storage space in vehicles is essential for keeping the interior organized and reducing clutter. Pickup trucks in particular, although well-known for their utility in moving cargo such as lumber, furniture, other large commercial items and personal items, can have passenger cabins with limited storage space.

### SUMMARY

The present disclosure provides a versatile vehicle seat that maximizes space in the passenger cabin and provides adjustable storage compartments which can be accessed from inside and outside a vehicle and from both sides of the vehicle.

In view of the state of the known technology, one aspect of the present disclosure is to provide a vehicle having a passenger cabin, a vehicle seat and a storage compartment. The passenger cabin has a driver side door configured to open and close a driver side door opening and a passenger side door configured to open and close a passenger side door opening. The vehicle seat is located inside the passenger cabin between the driver side door opening and the passenger side door opening. The vehicle seat includes a seat bottom and a seat backrest extending upward from the seat bottom. The storage compartment is located below the seat bottom. The storage compartment is configured to translate between (i) a stowed position in which the storage compartment is enclosed underneath the seat bottom, (ii) a first in-use position in which the storage compartment extends into the driver side door opening, and (iii) a second in-use position in which the storage compartment extends into the passenger side door opening.

A second aspect of the present disclosure is to provide a vehicle seat assembly having a base, a vehicle seat and a storage compartment. The base has a front side, a rear side, a first lateral side, and a second lateral side that is opposite the first lateral side in a lateral direction. The vehicle seat is located above the base and includes a seat bottom and a seat backrest. The storage compartment is located within the base below the vehicle seat and includes (i) a container with an inner lateral track therein extending in the lateral direction, and (ii) at least one divider configured to translate back and forth within the container along the inner lateral track and to be secured at different locations within the container to create multiple storage spaces of different sizes within the container.

A third aspect of the present disclosure is to provide another vehicle seat assembly having a base, a vehicle seat and a storage compartment. The base has a front side, a rear side, a first lateral side, and a second lateral side that is opposite the first lateral side in a lateral direction. The vehicle seat is located above the base and includes a seat bottom and a seat backrest. The storage compartment is located within the base below the vehicle seat. The storage compartment is configured to move in the lateral direction to be accessed (i) from the first lateral side of the base, by translating at least part of the storage compartment past the first lateral side of the base, and (ii) from the second lateral side of the base, by translating at least part of the storage compartment past the second lateral side of the base. The storage compartment includes a container and at least one divider. The divider is configured to translate within the container in the lateral direction to permit or prevent access to a portion of the container from the first lateral side of the base or the second lateral side of the base.

Other objects, features, aspects and advantages of the systems and methods disclosed herein will become apparent to those skilled in the art from the following detailed description, which, taken in conjunction with the annexed drawings, discloses exemplary embodiments of the disclosed systems and methods.

### BRIEF DESCRIPTION OF THE DRAWINGS

Referring now to the attached drawings which form a part of this original disclosure:

FIG. 1 is a top perspective view of an example embodiment of a vehicle having a vehicle seat in accordance with the present disclosure;

FIG. 2 is a top plan view of the vehicle of FIG. 1 with the doors closed;

FIG. 3 is a top plan view of the vehicle of FIG. 1 with the doors open;

FIG. 4 is a top plan view of the vehicle of FIG. 1, looking into the vehicle at Section A of FIG. 3 and illustrating the vehicle seat having a storage compartment in a stowed position;

FIG. 5 is another top plan view of the vehicle of FIG. 1 with the driver side doors open, looking into the vehicle at Section A of FIG. 3 and illustrating the vehicle seat having the storage compartment in a first in-use position;

FIG. 6 is another top plan view of the vehicle with the passenger side doors open, looking into the vehicle at Section A of FIG. 3 and illustrating the vehicle seat having the storage compartment in a second in-use position;

FIG. 7 is a front perspective view of the vehicle seat in a closed configuration and the storage compartment in the stowed position;

FIG. 8 is a front perspective view of the vehicle seat in a first open position and the storage compartment in the stowed position;

FIG. 9 is a front perspective view of the vehicle seat in a second open position and the storage compartment in the stowed position;

FIG. 10 is a front perspective view of the vehicle seat with the storage compartment in a first in-use position;

FIG. 11 is a front perspective view of the vehicle seat with the storage compartment in a second in-use position;

FIG. 12 is a side elevational view of a lower portion of the vehicle seat from the driver side;

FIG. 13 is a side perspective view of the lower portion of the vehicle seat shown in FIG. 12;

FIG. 14 is an example embodiment of a storage compartment in accordance with the present disclosure;

FIG. 15 is a cross-sectional view taken across lines B-B in FIG. 14;

FIG. 16 is an example embodiment of a storage compartment divider in accordance with the present disclosure;

FIG. 17 is another example embodiment of a storage compartment in accordance with the present disclosure; and

FIG. 18 is a close-up view taken at Section C in FIG. 18.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

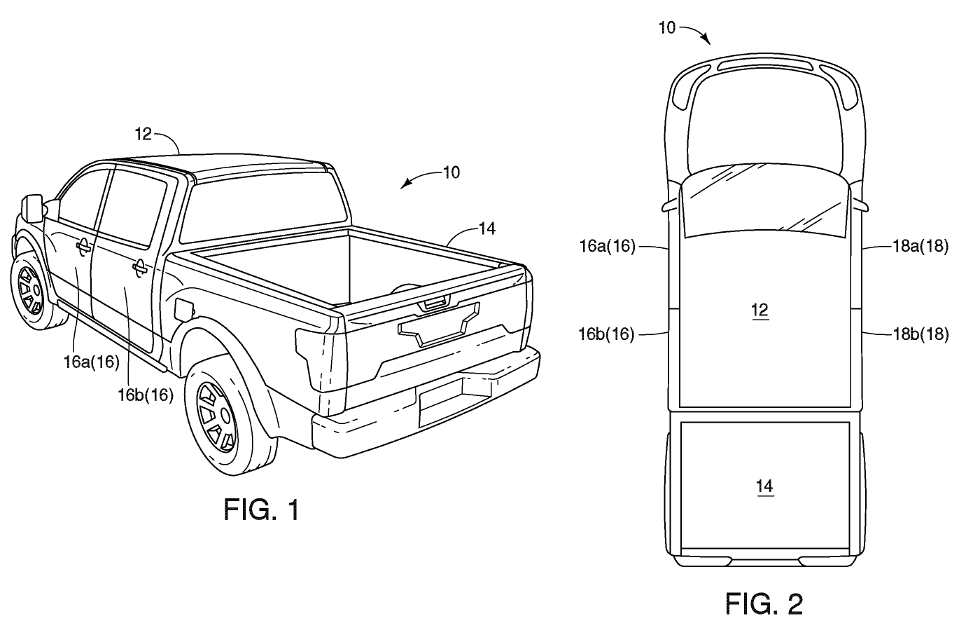

FIGS. 1 to 6 illustrate an example embodiment of a vehicle 10 having a vehicle seat assembly (or “vehicle seat”) 100 in accordance with the present disclosure. The illustrated vehicle 10 is a pickup truck with a passenger cabin 12 and a cargo bed 14. Although the vehicle seat 100 described herein is particularly advantageous for pickup trucks with limited cabin space, those of ordinary skill in the art will appreciate from this disclosure that the vehicle seat 100 and the various subassemblies and features described herein can also be applied to other types of vehicles 10. The cargo bed 14 can thus also be omitted in alternative embodiments for other vehicles 10.

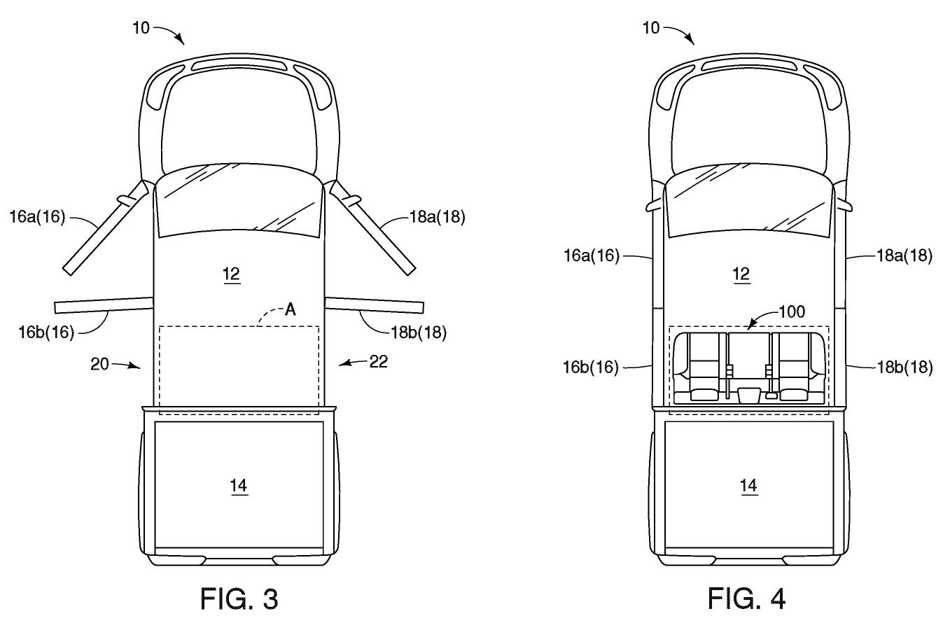

Referring first to FIGS. 1 to 3, on the driver’s side of the vehicle 10, the passenger cabin 12 has a front driver side door 16a and a rear driver side door 16b configured to open and close one or more driver side door opening 20. Likewise, on the passenger side of the vehicle 10, the passenger cabin 12 has a front passenger side door 18a and a rear passenger side door 18b configured to open and close one or more passenger side door opening 22. As seen in FIG. 3, the driver side doors 16a, 16b and the passenger side doors 18a open by pivoting outwardly toward the front side of the vehicle 10. In alternative embodiments, a vehicle 10 may have only one door on each side, may have multiple doors that pivot in different directions, and/or may have multiple doors that open and close multiple openings on each side of the passenger cabin 12.

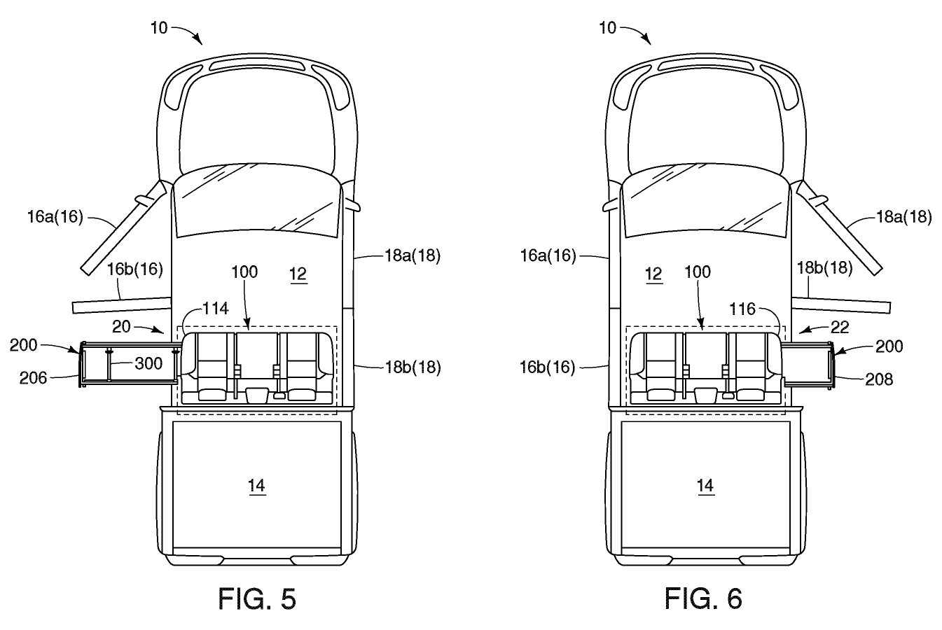

FIGS. 4 to 6 show a top view of the vehicle 10 looking into the passenger cabin 12 at the vehicle seat 100 in different configurations. The vehicle seat 100 is located inside the passenger cabin 12 between the driver side door opening 20 and the passenger side door opening 22. As seen in FIGS. 5 and 6, the vehicle seat 100 includes a storage compartment 200 that moves laterally between the driver side door opening 20 and the passenger side door opening 22. As used herein, the lateral direction of movement generally refers to the horizontal direction in FIGS. 4 to 6. As seen in FIG. 5, the storage compartment 200 further includes one or more movable dividers 300 configured to create multiple storage spaces of different sizes within the storage compartment 200. The dividers 300 move laterally within the storage compartment 200. As also seen in FIGS. 5 and 6, the doors 16a, 16b, 18a, 18b are configured to pivot completely out of the lateral path of the storage compartment 200.

FIGS. 4 to 6 show the storage compartment 200 in three different positions. FIG. 4 shows the storage compartment 200 in the stowed position, in which the storage compartment 200 is enclosed within the vehicle seat 100. FIG. 5 shows the storage compartment 200 in the first in-use position, in which the storage compartment 200 extends into the driver side door opening 20. FIG. 6 shows the storage compartment in the second in-use position, in which the storage compartment 200 extends into the passenger side door opening 22. The storage compartment 200 is thus configured to be accessed from outside the vehicle 10 on either side of the vehicle 10.

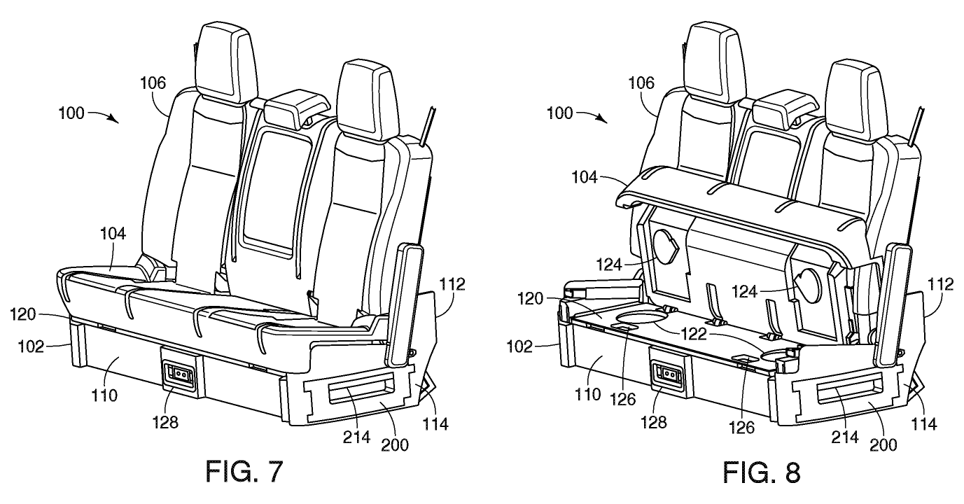

FIGS. 7 to 11 illustrate the vehicle seat 100 in more detail. The vehicle seat 100 generally includes a base 102, a seat bottom 104 located above the base 102, and a seat backrest 106 extending upward from the seat bottom 102. Here, the base 102 supports the seat bottom 104, the seat backrest 106 and the storage compartment 200. The seat bottom 104 can be moveably attached to either or both of the base 102 and the seat backrest 106. Likewise, the seat backrest 106 can be movably attached to either or both of the base 102 and the seat bottom 104.

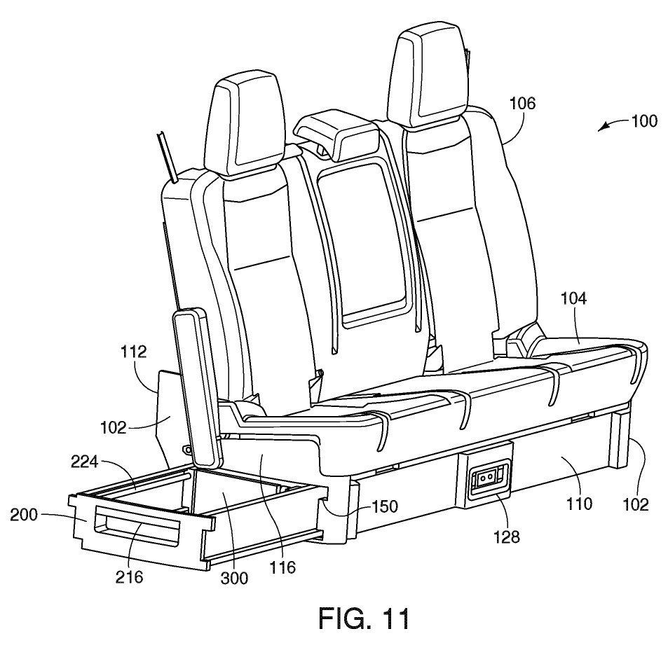

The storage compartment 200 is located within the base 102. When the storage compartment 200 moves between the stowed position (e.g., FIGS. 4 and 7 to 9), the first in-use position (e.g., FIGS. 5 and 10) and the second in-use position (e.g., FIGS. 6 and 11), the storage compartment 200 moves laterally within the base 102 beneath the seat bottom 104.

As seen in FIGS. 7 to 11, the base 102 generally includes a front side 110, a rear side 112, a first lateral side 114, and a second lateral side 116. The second lateral side 116 is opposite the first lateral side 114 in the lateral direction. The storage compartment 200 is configured to move within the base 102 in the lateral direction, at least partially past the first lateral side 114 in one direction (e.g., FIG. 10), and at least partially past the second lateral side 116 in the opposite direction (e.g., FIG. 11). This allows the storage compartment 200 to be accessed from the first lateral side 114 and the second lateral side 116, from both inside and outside of the vehicle 10. In the first in-use position (e.g., FIG. 5), the storage compartment 200 translates past the first lateral side 114 of the base 102 to extend into and/or past the driver side door opening 20. Similarly, in the second in-use position (e.g., FIG. 6), the storage compartment 200 translates past the second lateral side 116 of the base 102 to extend into and/or past the passenger side door opening 22. In the illustrated embodiment, the storage compartment 200 is also restricted by the vehicle seat 100 so that the storage compartment 200 only translates laterally when moving between the stowed position, the first in-use position and the second in-use position.

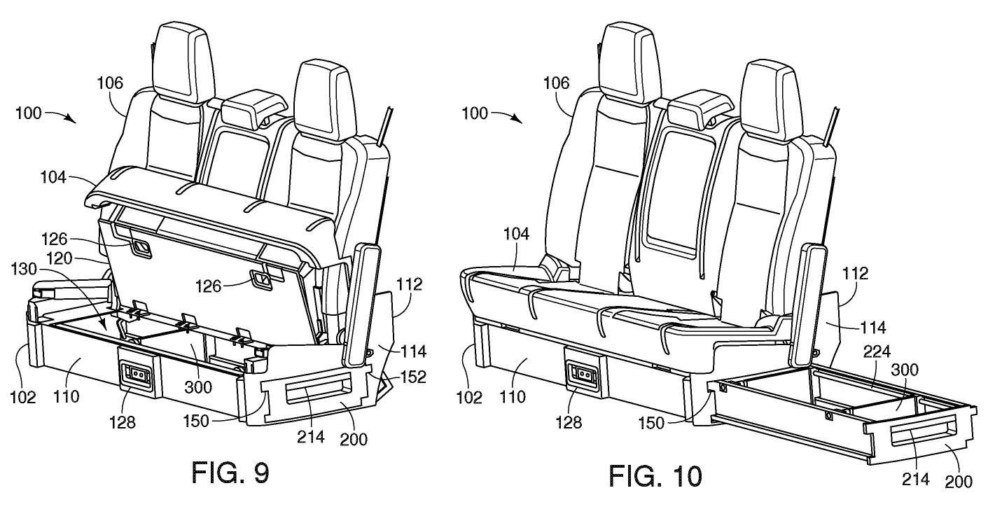

As seen in FIGS. 8 and 9, the seat bottom 104 pivots with respect to the base 102 to enable access to the storage compartment 200 when in the stowed position. Here, the base 102 includes an upper lid 120 for the storage compartment 200. FIG. 8 shows the seat bottom 104 pivoting away from the base 102 with the upper lid 120 still closed, while FIG. 9 shows both the seat bottom 102 and the upper lid 120 pivoting away from the base 102 to enable access to the entirety of the storage compartment 200 from above. In an embodiment, the vehicle seat 100 can include a lock which only allows the seat bottom 104 and/or the upper lid 120 to be moved by authorized persons. In another embodiment, the upper lid 120 can be formed as part of or attached to the seat bottom 104 and/or be configured to move with the seat bottom 104.

The vehicle seat 100 can also include other features due to how the storage compartment 200 is positioned and arranged to maximize usable space both within the passenger cabin 12 and within the vehicle seat 100 itself. In the illustrated embodiment, the seat bottom 104 includes seat warmers/coolers 124, and the upper lid 120 includes indentations 122 for the seat warmers/cooler 124 on the upper surface thereof, allowing the seat warmers/coolers 124 to be accessed or replaced as needed. The upper lid 120 also includes handles 126 for lifting the upper lid 120 from the base 102.

In the illustrated embodiment, the base 102 further includes a control panel 128. In an embodiment, and as discussed in more detail below, the control panel 128 can be configured to automatically set and/or cause the storage compartment 200 to move between the stowed position, the first in-use position, the second in-use position and/or other intermediate positions. The control panel 128 also controls the heat warmers/coolers 124 and USB ports located between the seat bottom 104 and the upper lid 120, and can be used for other functions such as moving the seat backrest 106 into different positions with respect to the seat bottom 104, unlocking the storage compartment 200 to be manually moved to different positions, and/or lifting the seat bottom 102 and/or the upper lid 120 to enable access to the storage compartment 200 in the stowed position.

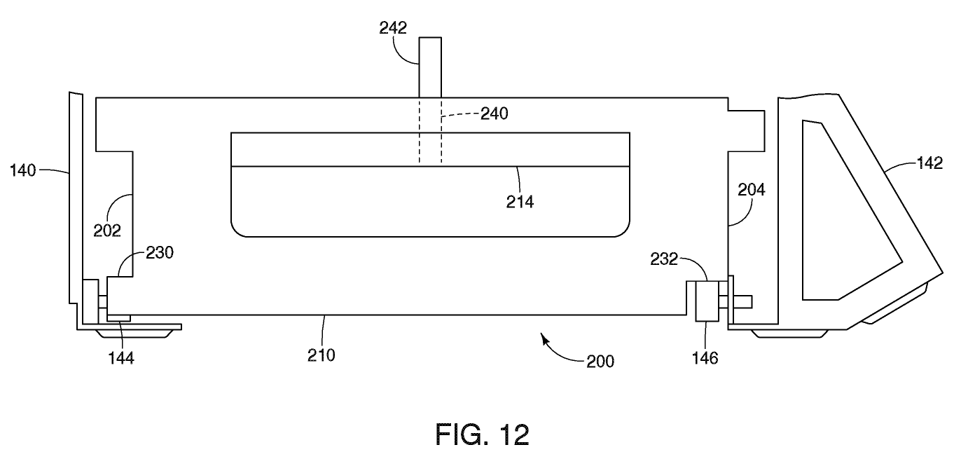

FIGS. 12 to 14 illustrate the storage compartment 200 in more detail. In the illustrated embodiment, the outer walls of the storage compartment 200 form a container having a front side 202, a rear side 204, a first lateral side 206, a second lateral side 208 and a bottom side 210. The second lateral side 208 is opposite the first lateral side 206 in the lateral direction. The sides of the storage compartment 200 create an inner space 212 which extends from the front side 202 to the rear side 204 and from the first lateral side 206 to the second lateral side 208. In the illustrated embodiment, the top of the storage compartment 200 is open to enable access from above when the seat bottom 102 and the upper lid 120 are lifted. In an alternative embodiment, the storage compartment 200 can include an upper surface.

As seen in FIGS. 5 and 6, the first lateral side 206 of the storage compartment 200 is configured to extend beyond the driver side door opening 20 of the vehicle 10 when the storage compartment 200 is in the first in-use configuration (e.g., FIG. 5). Similarly, the second lateral side 208 of the storage compartment 200 is configured to extend beyond the passenger side door opening 22 of the vehicle 10 when the storage compartment 200 is in the second in-use configuration (e.g., FIG. 6). In an embodiment, the first lateral side 206 of the storage compartment 200 extends completely past the driver side door(s) 16a, 16b of the vehicle 10 when the driver side door(s) 16a, 16b is/are open and the storage compartment 200 is in the first in-use position, and the second lateral side 208 of the storage compartment 200 extends completely past the passenger side door(s) 18a, 18b of the vehicle 10 when the passenger side door(s) 18a, 18b is/are open and the storage compartment 200 is in the second in-use position.

In the illustrated embodiment, the first lateral side 206 of the storage compartment 200 includes a first handle 214, and the second lateral side 208 of the storage compartment 200 includes a second handle 216. A person can use the first handle 214 to manually pull the first lateral side 206 past the driver side door opening 20 while the person stands outside the vehicle 10 on the driver side with the driver side door(s) 16a, 16b open. Likewise, the person can use the second handle 216 to manually pull the second lateral side 208 past the passenger side door opening 20 while the person stands outside the vehicle 10 on the passenger side with the passenger side door(s) 18a, 18b open.

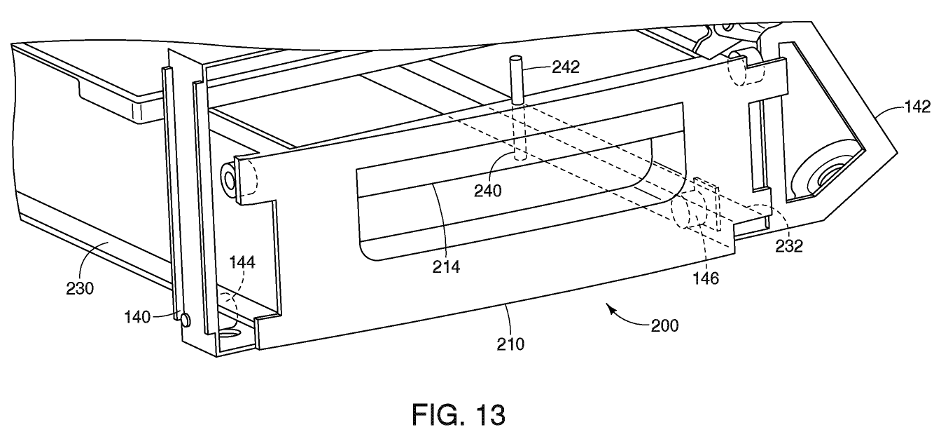

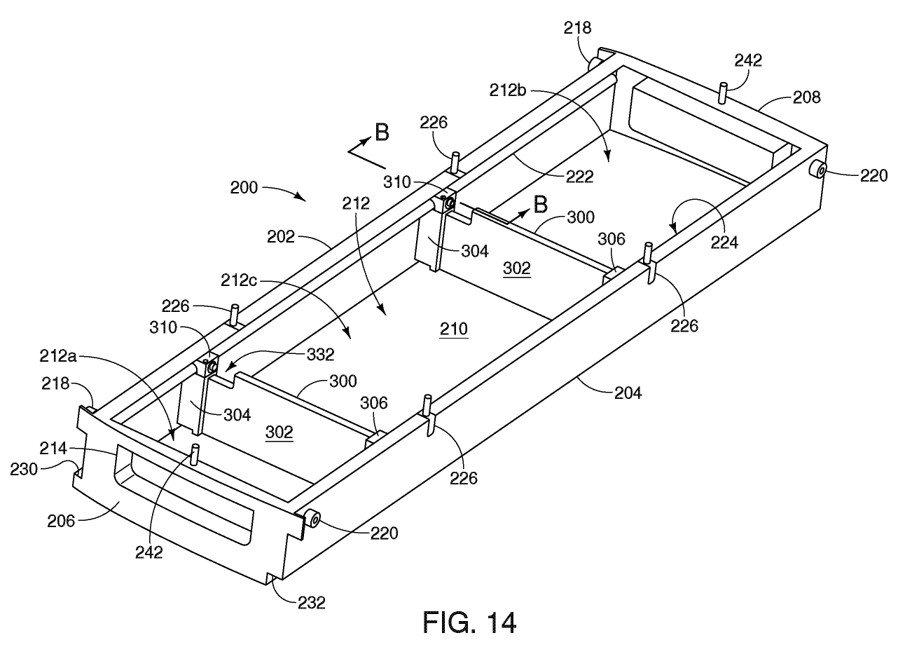

In the illustrated embodiment, the vehicle seat 100 and the storage compartment 200 include cooperating mechanisms enabling the storage compartment 200 to smoothly translate between the stowed position, the first in-use position and the second in-use position. As seen in FIGS. 12 and 13, the base 102 includes a front frame 140 at the front side 110 and a rear frame 142 at the rear side 112. The front frame 140 includes a first wheel 144 projecting inward toward the rear frame 142, and the rear frame 142 includes a second wheel 146 projecting inward toward the front frame 140. Although FIGS. 12 and 13 only show the first wheel 144 and the second wheel 146 on the first lateral side 114 of the base, the second lateral side 116 also includes a first wheel 144 and a second wheel 146 at corresponding locations. As seen in FIG. 14, the storage compartment 200 further includes first wheels 218 projecting outward from opposite ends of the front side 202 and second wheels 220 projecting outward from opposite ends of the rear side 204.

As further seen in FIGS. 12 to 14, the storage compartment 200 includes a first track 230 configured to cooperate with the first wheels 144 and a second track 232 configured to cooperate with the second wheels 146. The first track 230 and the second track 232 each extend from the first lateral side 206 to the second lateral side 208 and include a generally horizontal surface that cooperates with the respective first and second wheels 144, 146. As best seen in FIGS. 13 and 14, the illustrated first track 230 includes a horizontal surface projecting outwardly and forward from the front side 202 of the storage compartment 200, and the illustrated second track 232 includes a horizontal surface projecting inwardly and forward from the rear side 204 of the storage compartment 200. The horizontal surfaces of the first and second tracks 230, 232 are supported on and move over the respective first and second wheels 144, 146 when the storage compartment 200 translates back and forth in the lateral direction. In alternative embodiments, the first and second wheels 144, 146 can be supported on and translate over the horizontal surfaces of the first and second tracks 230, 232, and the first and second tracks 230, 232 can project inwardly or outwardly of the storage compartment 200 and can be located at any height of the storage compartment 200. As seen in FIGS. 9 to 11, the base 102 can include similar tracks 150, 152 (e.g., generally horizontal surfaces) configured to support and/or cooperate with the respective first and second wheels 218, 220 of the storage compartment 200.

In an embodiment, a person can use the control panel 128 to control movement of the storage compartment 200. In this embodiment, the vehicle seat 100 includes a computer-controlled mechanism for translating the storage compartment 200 back and forth within the base 200 without any manual force applied. For example, the vehicle seat 100 can include motors that control rotation of the first and second wheels 144, 146 to cause automated lateral translation of the storage compartment 200.

In an embodiment, the vehicle owner can set one or more lateral positions for the storage compartment 200 using the control panel 128. Such a setting can be useful for limiting access to certain portions of the storage compartment 200 from one or both sides of the vehicle 10. For example, the vehicle owner can also use the control panel 128 to set the first in-use position and the second in-use position for the storage compartment 200 and/or to set the maximum extension for the storage compartment 200 in each lateral direction. Such a setting can also be useful in situations where the vehicle 10 is parked in a confined space. Since the storage compartment 200 can be capable of extending past the doors of the vehicle 10, the vehicle owner may want to restrict the extension of the storage compartment 200 to avoid contacting walls or other vehicles.

In an embodiment, the maximum extension of the storage compartment 200 on either side is manually set as desired by the vehicle owner. As seen in FIG. 14, the storage compartment 200 can include moveable and/or removeable lateral stoppers 226 which overlap with a portion of the base 102 when viewed from the lateral direction. The vehicle owner can pull the storage compartment 200 into a position intended to be the maximum extension on either side of the vehicle 10, and then set the lateral stoppers 226 so that they contact the base 102 and restrict the storage compartment 200 from moving further outward than that lateral position.

In another embodiment, the maximum extension of the storage compartment 200 on either side is part manually and part automatically set as desired by the vehicle owner. The vehicle owner can pull the storage compartment 200 into a position intended to be the maximum extension, and then input into the control panel 128 that the set position is the desired maximum extension. The control panel 128 can thereafter control the movement of the storage compartment 200 so that the storage compartment 200 does not exceed the maximum extension. Alternatively, the control panel 128 can automatically move any lateral stoppers 226 to restrict extension when the storage compartment 200 is manually pulled in a lateral direction.

In another embodiment, the maximum extension of the storage compartment 200 on either side is automatically set as desired by the vehicle owner using the control panel 128. For example, the vehicle owner can use the control panel 128 to input a maximum extension distance. Alternatively, the vehicle 10 itself can use sensors, cameras or other technology to determine the presence of walls or other vehicles and set the maximum extension distance so as to avoid contact by the storage compartment 200. The vehicle owner can also use the control panel 128 to set other intermediate positions for the storage compartment 200 besides the maximum extension distance in each direction. The person can then use the control panel 128 to select the stowed position, the first in-use position, the second in-use position and/or another intermediate or fully extended position, and the storage compartment 200 will automatically move to that position upon selection.

As best seen in FIGS. 10, 11 and 14, the storage compartment 200 includes at least one lateral track 222, 224 configured to cooperate with one or more lateral divider 300. Here, the storage compartment 200 includes a first lateral track 222 located inside the inner space 212 adjacent the front side 202 and a second lateral track 224 located inside the inner space 212 adjacent the rear side 204. The first lateral track 222 and the second lateral track 224 each generally extend laterally between first lateral side 206 and the second lateral side 208 of the storage compartment 200. In the illustrated embodiment, the first and second lateral tracks 222, 224 include rods extending in the lateral direction between the first lateral side 206 and the second lateral side 208 of the storage compartment 200, but other types of tracks 222, 224 can also be used.

In the illustrated embodiment, the storage compartment 200 further includes a latch 240 and an end stopper 242. The end stopper 242 moves between an extended position and a retracted position. In the extended position, the end stopper 242 overlaps with a portion of the base 102 when viewed from the lateral direction. In the retracted position, the end stopper 242 does not overlap with the portion of the base 102 when viewed from the lateral direction. The respective latches 240 are located underneath the handles 214, 216 and operatively coupled to the respective end stoppers 242, such that actuating the latch 240 causes the end stopper 242 to move from the extended position to the retracted position, so that the first lateral side 206 and/or the second lateral side 208 can move past the first lateral side 114 and/or the second lateral side 116 of the base 102.

The latches 240 and the end stoppers 242 can have a dual purpose. Each latch 240 and end stopper 242 is configured to prevent the storage compartment 200 from moving out the stowed configuration in a lateral direction unless desired. Each end stopper 242 is also configured to prevent the storage compartment 200 from detaching from the base 102 when the storage compartment 200 is fully extended in the opposite lateral direction. For example, when the storage compartment 200 is in the stowed configuration, a person can actuate the latch 240 at the first lateral side 206 of the storage compartment 200 to retract the end stopper 242, which allows the person to pull the storage compartment 200 out of the first lateral side 114 in the direction of the driver side door opening 20. When the storage compartment 200 has fully extended in the direction of the driver side, the opposite stopper 242 on the second lateral side 208 of the storage compartment 200 contacts the base 102 at or near the first lateral side 114 and prevents the storage compartment 200 from translating further. The same is true in the opposite direction on the passenger side. Thus, the opposite stoppers 242 on the first lateral side 206 and the second lateral side 208 can cooperate to both release the storage compartment 200 from the stowed configuration and to then keep the storage compartment 200 from extending past a certain point in the lateral direction and detaching from the base 102. In an embodiment, the stopper 242 can be a stopper pin and/or can be located at other locations of the storage compartment 200.

Referring now to FIGS. 14 to 18, the storage compartment 200 includes one or more lateral dividers 300. For example, the illustrated storage compartment 200 includes two lateral dividers 300. The two lateral dividers 300 are configured to translate back and forth in a lateral direction between the first lateral side 206 and the second lateral side 208 of the storage compartment 200 to create multiple storage spaces of different sizes within the storage compartment 200. In FIG. 14, the two lateral dividers 300 divide the inner space 212 of the storage compartment 200 into three smaller spaces: (1) a first (left side) storage space 212a between the first lateral side 206 and one of the lateral dividers 300, (2) a second (right side) storage space 212b between the second lateral side 208 and the other lateral divider 300, and (3) a third (middle) storage space 212c between the two lateral dividers 300. A person can adjust the relative sizes of the storage spaces 212a, 212b, 212c by moving the lateral dividers 300 closer to each other and/or the first lateral side 206 or second lateral side 208 of the storage compartment 200. A person can also move the lateral dividers 300 to essentially close off storage space from one or both sides of the vehicle 10 as desired, depending on the maximum lateral extension of the storage container 200.

FIGS. 14 to 18 illustrate several example embodiments of lateral dividers 300. In the illustrated embodiments, each of the lateral dividers 300 includes a dividing surface 302 extending from a first end structure 304 to a second side end structure 306. Here, the dividing surface 302 is a generally flat surface that is sized and shaped to extend horizontally between the front side 202 and the rear side 204 of the storage compartment 200, and to extend vertically between the bottom surface 212 and an upper side of the storage compartment 200. When placed as shown in FIG. 14, the first end structure 304 is located adjacent to the front side 202 of the storage compartment 200, and the second end structure 306 is located adjacent to the rear side 204 of the storage compartment 200.

The dividers 300 are configured to translate back and forth along the first lateral track 222 and/or the second lateral 224 of the storage compartment 200. In the illustrated embodiments, the divider 300 includes a locking mechanism 310 configured to secure the divider 300 to the first lateral track 222.

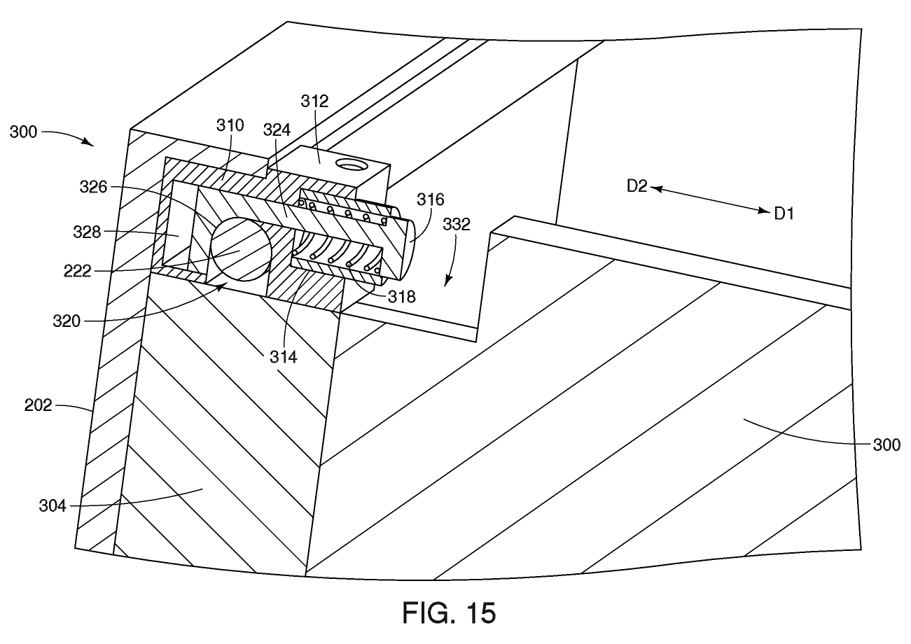

FIG. 15 shows a first example embodiment of a locking mechanism 310. In this embodiment, the locking mechanism 310 includes a housing 312, an actuator casing 314 (e.g., a button casing), an actuator 316 (e.g., a button) and a biasing mechanism 318 (e.g., a spring). The housing 312 further includes an aperture 320 sized and shaped to receive the first lateral track 222 therethrough. Here, the aperture 320 is formed between the bottom side of the housing 312 and the top side of the first end structure 304. The actuator casing 314 can be formed as part of the housing 312 or as a separate piece held within the housing 312.

As further seen in FIG. 15, the actuator/button 316 includes a shaft 324 and a contact portion 326 for contacting the first lateral track 222 to lock the lateral divider 300 into place. In this embodiment, the biasing mechanism 318 biases the actuator/button 316 out of the housing 312 in the direction D1. In use, a person presses the actuator/button 316 in the direction D2 against the biasing force, which pushes the contact portion 326 off of the first lateral track 222 and into an empty space 328 within the housing 312. This releases the locking mechanism 310 from the first lateral track 222 so that the person can move the lateral divider 300 back and forth along the first lateral track 222 and into a new lateral position. When the lateral divider 300 has moved to a new intended lateral position along the first lateral track 222, the person releases the actuator/button 316 to allow the biasing mechanism 318 to bias the actuator 316 back in the direction D1 so that the contact portion 326 again contacts the first lateral track 222 to secure the divider 300 in that lateral position. The contact portion 326 can include rubber or another material that will not easily slip along the first lateral track 222. In the illustrated embodiment, the dividing surface 302 of the divider 300 further includes an indentation 332 that provides space for the person to place their fingers to press the actuator/button 316. Since the locking mechanism 310 can be operated with only one hand, a person can move the lateral divider 300 along the lateral tracks 222, 224 with one hand while the other hand actuates the actuator/button 316

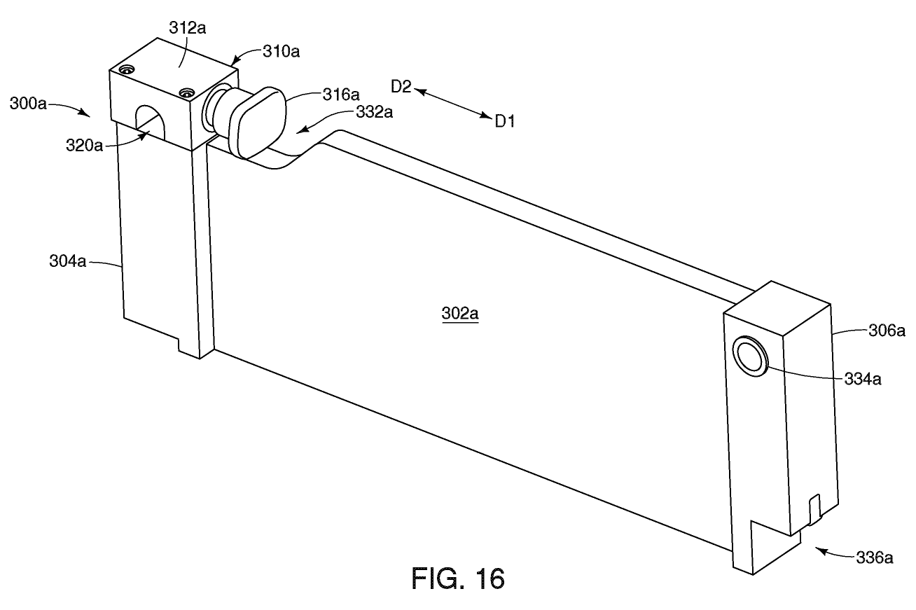

FIG. 16 illustrates an alternative embodiment of a lateral divider 300a including an alternative locking mechanism 310a. Like the divider 300, the divider 300a includes a dividing surface 302a extending from the first end structure 304a to the second end structure 306a. The locking mechanism 310a is substantially similar to the locking mechanism 310, except that the actuator 316a here is a handle that is biased in the direction D2 into the housing 312a. A person releases the locking mechanism 310a from the first lateral track 222 by pulling the actuator/handle 316a in the direction D1, which pulls the respective contact portion inside the housing 312a away from the first lateral track 222 positioned in the aperture 320a. The person can then translate the divider 300a laterally, and when in a desired position release the actuator/handle 316a to allow the biasing mechanism to bias the actuator/handle 316a back in the direction D2 so that the contact portion again contacts the first lateral track 222 to secure the divider 300a in that lateral position. Like with the divider 300, the dividing surface 302a of the divider 300a further includes an indentation 332a that provides space for the person to pull the actuator/handle 316a.

As also seen in FIG. 16, the second end structure 306a of the lateral divider can include a second aperture 334a for the second lateral track 224 and an indentation 336a corresponding to the second track 232 which cooperates with a corresponding feature on the base 102 when the storage compartment 200 itself is moved laterally. A similar feature can also be included on the first end structure 304a as needed

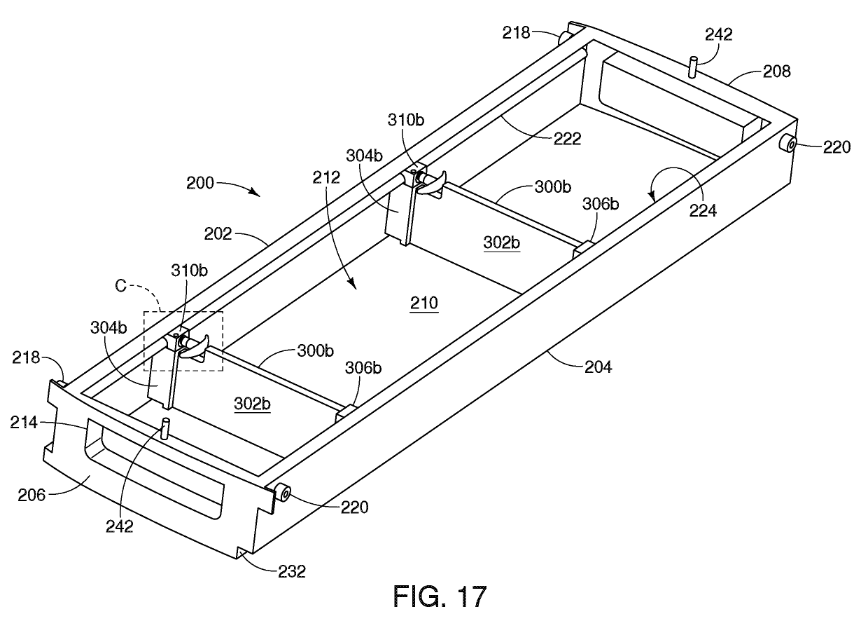

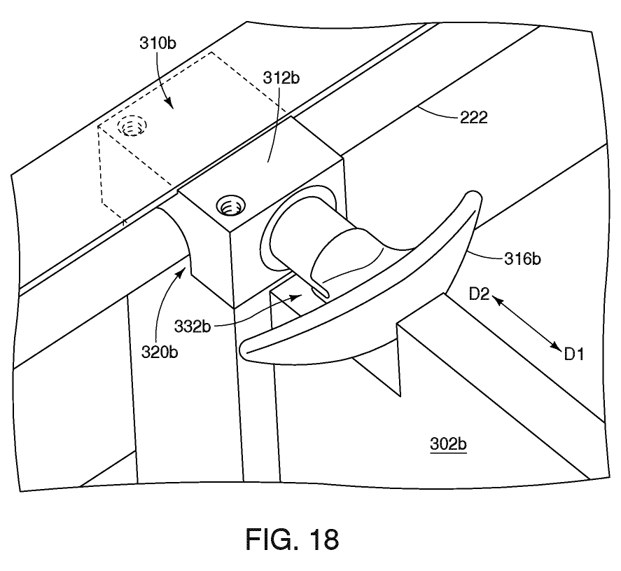

FIG. 17 illustrates a storage compartment 200 equipped with another example embodiment of a lateral dividers 300b, while FIG. 18 illustrates the locking mechanism 310b of the divider 300b in more detail. Like the other embodiments, the divider 300b includes a dividing surface 302b extending from the first end structure 304b to the second end structure 306b. The locking mechanism 310b is substantially similar to the locking mechanism 310a, with the actuator 316b being a different type of handle that is biased in the direction D2 into the housing 312b. A person releases the locking mechanism 310b from the first lateral track 222 by pulling the actuator/handle 316b in the direction D1, which pulls the respective contact portion away from the first lateral track 222 positioned in the aperture 320b. The person can then translate the divider 300b laterally, and when in a desired position release the actuator/handle 316b to allow the biasing mechanism to bias the actuator/handle 316b back in the direction D2 so that the contact portion again contacts the first lateral track 222 to secure the divider 300b in that lateral position. Like with the dividers 300 and 300a, the dividing surface 302b of the divider 300b further includes an indentation 332b that provides space for the person to place their fingers to pull the actuator 316b. With the lateral divider 300b, the actuator/handle is wider in the lateral direction, and the indentation 332b is smaller because fingers do not need to fit into the indentation 332b.

Those of ordinary skill in the art will recognize from this disclosure that any of the features of any of the lateral dividers 300, 300a, 300b can be applied to the other embodiments. The dividers 300, 300a, 300b can further be configured to secure to the first lateral track 222 and/or the second lateral track 224 by other mechanisms such as by clamps, tightening screws or other mechanisms. In an embodiment, the control panel 128 can also be used to automatically move and lock the lateral dividers 300, 300a, 300b.

As seen in the various embodiments disclosed herein, the storage compartment 200 is configured to translate with respect to the base 102 in the same lateral direction that the lateral dividers 300, 300a, 300b translate within the storage compartment 200. The positioning/locking of the lateral dividers 300, 300a, 300b in specific lateral positions can effectively permit or prevent access to a portion of the storage compartment 200 from the first lateral side 114 of the base 102 or the second lateral side 116 of the base 102. At the same time, the seat bottom 102 pivots away from the base 102 to enable access to an entirety of the storage compartment 200 regardless of a relative position of the dividers 300, 300a, 300b.

Similar to with the stoppers 226, 242, in an embodiment, the lateral dividers 300, 300a, 300b can include a stopper projecting from the dividing surface 302, the first side end 304 and/or the second side end 306 which contacts the base 102 when the storage compartment 200 is translated laterally in one or both directions. In this embodiment, the positioning of the lateral divider 300, 300a, 300b and/or stoppers 226, 242 affects how far the storage compartment 200 is permitted to extend in the lateral direction.

In an embodiment, a person can use the positioning of the lateral dividers 300, 300a, 300b, the stoppers 226, 242 and/or other elements to permit or prevent access to a portion of the storage compartment 200 from the first lateral side 114 of the base 102 or the second lateral side 116 of the base 102. For example, in the embodiment shown in FIG. 14, stoppers on top of or adjacent to the lateral dividers 300 would only allow the first (left side) storage space 212a between the first lateral side 206 and one of the lateral dividers 300 to be accessed from the driver side of the vehicle 10, would only allow the second (right side) storage space 212b between the second lateral side 208 and the other lateral divider 300 to be accessed from the passenger side of the vehicle 10, and would only allow the third (middle) storage space 212c between the both lateral dividers 300 to be accessed from above by pivoting the seat bottom 104 and/or upper lid 120 upwardly. Thus, the owner of the vehicle 10 can use a combination of the lateral dividers 300, the extension of the storage compartment 200, and/or positioning of any stoppers 226, 242 or other elements to allow and/or restrict access to different spaces formed by the lateral dividers 300.

Those of ordinary skill in the art will recognize from this disclosure that arranging the vehicle seat 100 and storage compartment 200 as described herein provides additional opportunities to add features and mechanism due to how the usable space is created both within the passenger cabin 12 and within the vehicle seat 100 itself.

The embodiments described herein provide improved systems, methods and devices for creating storage space within a vehicle. These systems and methods are advantageous, for example, because they can be adjusted in size and/or accessed from multiple locations both inside or outside of the vehicle. These systems and methods are also advantageous, for example, because they can be used to allow and/or restrict access from different locations within and outside the vehicle. It should be understood that various changes and modifications to the systems and methods described herein will be apparent to those skilled in the art and can be made without diminishing the intended advantages.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle comprising:
a passenger cabin having a driver side door configured to open and close a driver side door opening and a passenger side door configured to open and close a passenger side door opening;
a vehicle seat located inside the passenger cabin between the driver side door opening and the passenger side door opening, the vehicle seat including a seat bottom and a seat backrest extending upward from the seat bottom;
a storage compartment located below the seat bottom, the storage compartment configured to translate between (i) a stowed position in which the storage compartment is enclosed underneath the seat bottom, (ii) a first in-use position in which the storage compartment extends into the driver side door opening, and (iii) a second in-use position in which the storage compartment extends into the passenger side door opening.

2. The vehicle of claim 1, wherein
the vehicle seat includes a base, and
the seat bottom pivots with respect to the base to enable access to the storage compartment when the storage compartment is in the stowed position.

3. The vehicle of claim 1, wherein
the storage compartment remains partially underneath the seat bottom when in the first in-use position and the second in-use position.

4. The vehicle of claim 1, wherein
the storage compartment is restricted by the vehicle seat so that the storage compartment only translates laterally with respect to the vehicle seat when moving between the stowed position, the first in-use position and the second in-use position.

5. The vehicle of claim 1, wherein
a first lateral edge of the storage compartment extends completely past the driver side door when the driver side door is open and the storage compartment is in the first in-use position.

6. The vehicle of claim 1, wherein
a second lateral edge of the storage compartment extends completely past the passenger side door when the passenger side door is open and the storage compartment is in the second in-use position.

7. The vehicle of claim 1, wherein
the storage compartment includes a first lateral side configured to extend beyond the driver side door opening when the storage compartment is in the first in-use configuration and a second lateral side configured to extend beyond the passenger side door opening when the storage compartment is in the second in-use configuration, and
the storage compartment includes at least one divider configured to translate back and forth in a lateral direction between the first lateral side and the second lateral side to create multiple storage spaces of different sizes within the storage compartment.

8. A vehicle seat assembly comprising:
a base having a front side, a rear side, a first lateral side, and a second lateral side that is opposite the first lateral side in a lateral direction;
a vehicle seat located above the base, the vehicle seat including a seat bottom and a seat backrest; and
a storage compartment located within the base below the vehicle seat, the storage compartment including (i) a container with an inner lateral track therein extending in the lateral direction, and (ii) at least one divider configured to translate back and forth within the container along the inner lateral track and to be secured at different locations within the container to create multiple storage spaces of different sizes within the container.

9. The vehicle seat assembly of claim 8, wherein
the at least one divider includes a spring-loaded attachment mechanism configured to be secured at different locations along the inner lateral track.

10. The vehicle seat assembly of claim 9, wherein
the at least one divider includes an indentation in a top surface thereof enabling access to adjust the spring-loaded attachment mechanism.

11. The vehicle seat assembly of claim 8, wherein
the seat bottom pivots away from the base to enable access to the multiple storage spaces from above.

12. The vehicle seat assembly of claim 8, wherein
the storage compartment is configured to translate with respect to the base in the same lateral direction that the at least one divider translates within the container.

13. The vehicle seat assembly of claim 8, wherein
the storage compartment is configured to be accessed from the first lateral side of the base by translating at least partially past the first lateral side of the base, and from the second lateral side of the base by translating at least partially past the second lateral side of the base.

14. The vehicle seat assembly of claim 13, wherein
the vehicle seat is located within a passenger cabin of a vehicle having a driver side door configured to open and close a driver side door opening and a passenger side door configured to open and close a passenger side door opening, and
the storage compartment extends past the driver side door opening when translated past the first lateral side of the base and past the passenger side door opening when translated past the second lateral side of the base.

15. A vehicle seat assembly comprising:
a base having a front side, a rear side, a first lateral side, and a second lateral side that is opposite the first lateral side in a lateral direction;
a vehicle seat located above the base, the vehicle seat including a seat bottom and a seat backrest; and
a storage compartment located within the base below the vehicle seat, the storage compartment configured to move in the lateral direction to be accessed (i) from the first lateral side of the base, by translating at least part of the storage compartment past the first lateral side of the base, and (ii) from the second lateral side of the base, by translating at least part of the storage compartment past the second lateral side of the base,
the storage compartment including a container and at least one divider, the at least one divider configured to translate within the container in the lateral direction to permit or prevent access to a portion of the container from the first lateral side of the base or the second lateral side of the base.

16. The vehicle seat assembly of claim 15, wherein
the storage compartment includes an inner lateral track extending in the lateral direction,
the at least one divider translates back and forth within the container along the inner lateral track, and
the at least one divider includes a spring-loaded attachment mechanism configured to be secured at different locations along the inner lateral track.

17. The vehicle seat assembly of claim 16, wherein
the at least one divider includes an indentation in a top surface thereof enabling access to adjust the spring-loaded attachment mechanism.

18. The vehicle seat assembly of claim 15, wherein
the seat bottom pivots away from the base to enable access to an entirety of the container regardless of a relative position of the at least one divider.

19. The vehicle seat assembly of claim 15, wherein
the storage compartment includes at least one stopper configured to adjust a maximum lateral extension of the storage compartment.

20. The vehicle seat assembly of claim 15, wherein
the vehicle seat is located within a passenger cabin of a vehicle having a driver side door configured to open and close a driver side door opening and a passenger side door configured to open and close a passenger side door opening, and
the storage compartment extends past the driver side door opening when translated past the first lateral side of the base and past the passenger side door opening when translated past the second lateral side of the base.
